(19) United States
(12) Patent Application Publication
(10) Pub. No.: US 2020/0168962 A1
(43) Pub. Date: May 28, 2020

(54) A Structural Battery

(71) Applicant: CAPE BOUVARD TECHNOLOGIES PTY LTD, Mosman Park (AU)

(72) Inventors: Kim Schlunke, Mosman Park (AU); Peter Baskovich, Mosman Park (AU); Lindsay Wood, Mosman Park (AU)

(21) Appl. No.: 16/637,277

(22) PCT Filed: Aug. 8, 2018
(86) PCT No.: PCT/AU2018/050830

§ 371 Date: Feb. 7, 2020

(30) Foreign Application Priority Data
Aug. 8, 2017 (AU) 2017903159

(51) Int. Cl. H01M 10/653; H01M 2/10; H01M 10/6569; H01M 10/613; H01M 10/6568; H01M 10/625

(52) U.S. Cl. CPC H01M 10/653; H01M 2/1077; H01M 10/6569; H01M 2/1083; H01M 10/6568; H01M 10/625; H01M 10/613

(57) ABSTRACT

A structural battery (10) for delivering electric power to an application requiring electric power comprising: a container (12) of a first material; and a core (30) for a plurality of electric cells (34,134) provided within said container (12) wherein the container (12) and the core (30) of the composite structure (10) together form a structural member having resistance to shear forces, compression forces, tension forces, torsional forces and longitudinal and transverse bending forces imposed on said structural member by the application and wherein said core (30) comprises a means for controlling temperature (141, 150, 152, 250) of said core (30), preferably within a predetermined temperature range.

The invention relates to a structural battery, and more particularly to thermal control.

The Applicant has developed composite and composite sandwich structures suitable as a structural battery comprising a container of a first material; and a core for accommodating a plurality of electric cells provided within said container wherein the container and the housing of the composite structure together form a structural member having resistance to shear forces compression forces, tension forces, torsional forces and longitudinal and transverse bending forces imposed on said structural member by the application. Further description of one embodiment is provided in the Applicant's co-pending International Patent Application filed 8 Aug. 2018 under Attorney Docket No. P42453PCAU, the contents of which are hereby incorporated herein by reference.

Heat is expected to be generated during operation of the structural battery, particularly in the housing or core which comprises a plurality of electrical cells generating current. Heat is primarily generated due to electric cell impedance. Such heat generation requires thermal management or control so that heat does not build up to the point that battery performance will be degraded or thermal runaway occurs. Instances may also be expected in which the structural battery requires heating to ensure the performance of the battery is not degraded. For example, if battery core temperature falls too low, performance can also degrade. A suitable operating temperature range for a battery involves weighing a number of considerations including battery chemistry, desired service life and desired power output. Low temperature may affect power output and too high a temperature may speed battery degradation rate. In some cases, a thermal runaway condition could occur and this is undesirable.

It is an object of the present invention to provide a structural battery that facilitates the safe, efficient and effective use of electric power in a range of applications while minimising performance degradation due to poor thermal management whether in terms of excessive heating or cooling.

With this object in view, the present invention provides a structural battery for delivering electric power to an application comprising:

a container; and

a core for accommodating a plurality of electric cells provided within said container

wherein said core comprises a means for controlling temperature of said core, preferably within a predetermined temperature range.

The predetermined temperature range for the structural battery may be selected having regard to factors such as electrochemical performance and power output and battery life. Such factors need to be balanced. The temperature range may therefore vary with the battery chemistry and design. A desirable temperature range is 0° C. to 50° C., preferably 15° C. to 35° C.

The container and the core of the composite structure together form a structural member having resistance to shear forces, compression forces, tension forces, torsional forces and longitudinal and transverse bending forces imposed on said structural member by the application. The core may be as described in the Applicant's International Patent Application filed 8 Aug. 2017 under Attorney Docket No. P42453PCAU, the contents of which are hereby incorporated herein by reference.

The temperature control means may include a heat absorbing material located within the core. The heat absorbing material, which is desirably intumescent, may be arranged throughout the core as elements or units, for example of a material that changes state or phase from solid to char, solid to liquid, solid to gas or liquid to gas, the change of state requiring sufficient heat to prevent thermal runaway. This option, which may employ a suitable polymer, may be preferred to prevent damaging or unsafe overheating of the housing and structural battery.

The temperature control means may include a heat exchanger system that includes first heat exchanger(s) to add or remove heat from the core so that core temperature or battery operating temperature is maintained within a predetermined temperature range representing a balance between electrochemical efficiency and battery service life. Rate of heat addition or removal may depend on battery operating conditions. For example, the application may cause electric cells to heat to a higher temperature or heat at a higher rate. The converse may also be true. The temperature control means may adapt to both situations. The temperature control means typically includes a control unit to implement such control.

Conveniently, a first heat exchanger operates through heat transfer to and from a heat transfer material, preferably a fluid such as a refrigerant selected not to interfere with structural battery operation under normal operating conditions. The heat exchanger system may include a suitable pump for circulating heat transfer fluid through the first heat exchanger and heat exchanger system and its component heat exchangers. Heat transfer fluid flow rate may be controlled to reduce error between a target battery operating temperature and sensed temperature which may depend on battery operating conditions as alluded to above. Other temperature parameters could be used for control, for example heat transfer fluid temperature. Information links, such as thermistors, may be included within the core to sense battery operating temperature.

The heat exchanger system desirably also includes second heat exchanger(s) to add or remove heat from the heat transfer fluid so that this can be recirculated for temperature control as required. Once through flow of heat transfer fluid will typically be impractical. Such second heat exchangers may include, for example, one or more of a radiator, chiller or heater depending on whether the second heat exchanger(s) add or remove heat from the heat transfer fluid.

The core advantageously accommodates the electric cells within a spaces pre-formed in a material or a sub-structure resistant to compression and shear loads as well as temperature. A portion of the material or sub-structure could be made electrically conductive to enable flow of electric current between and away from the inter-connected electric cells and towards the application. Thermal conductivity also assists heat transfer to facilitate temperature control. A heat absorbing material could be included in one or more elements or units in this portion as described above. Where a heat exchanger system is used, at least part of the heat exchanger system, for example the first heat exchanger, may be provided in the material or sub-structure to conduct heat to or from the core structure.

Honeycomb or like core structures of lightweight material such as a conductive light metal or light metal alloy; for example aluminium, are advantageous. Such core structures should have high strength and stiffness with resistance to shear yet be cost effective to produce. Suitable core structures are also described in the Applicant's co-pending International Patent Applications filed 8 Aug. 2018 under Attorney Docket Nos. P42453PCAU, P43190PCAU, P43209PCAU and P43210PCAU, the contents of which are hereby incorporated herein by reference.

Accommodation for electric cells in such core structures is provided by spaces formed by the layout or framework of core elements or layers forming the core structure. The core elements of the core structure may include heat transfer fluid passage means such as ducts, galleries or channels through which heat transfer fluid flows to enable heat transfer to or from the electric cells, and their accommodating spaces, to or from the heat transfer fluid. Such fluid passage means are included within the first heat exchanger(s). The core element fluid passages, including for example such ducts or galleries as well as core elements may be configured to optimise heat transfer. Further provision may be made for controlling thermal runaway as described in the Applicant's co-pending International Patent Application filed 8 Aug. 2018 under Attorney Docket No. P43210PCAU, the contents of which are incorporated herein by reference.

The number of electric cells and number of spaces selected to accommodate such electric cells within the structural battery is determined with reference to the electric power requirements of the application. The electric cells most desirably each have the same current and voltage rating. The cell type is not critical though suitable batteries could be selected from rechargeable batteries, such as from the lithium ion battery class, such as for example 18650 type batteries rated at 3.7 v approximately or 2170 type batteries. The application may require many electrical cells dependent on the application, perhaps thousands in the case of an electric motor vehicle. These electric cells generate heat during operation and the temperature control means is selected to control heat output. As heating may be required, a desired temperature control means is selected to control heat input, at least on start up. The heat exchanger system includes suitably rated first and second heat exchangers to control the temperature of the battery core and thereby maintain the electric cells of the structural battery at acceptable operating temperature. For example, heat output from the interconnected electric cells can be calculated allowing, with consideration of other relevant parameters, estimation of the battery operating temperature under particular conditions. Heat exchangers may then be designed to control the required battery operating temperature within acceptable limits. If a heat transfer fluid is used, required flow rates can be calculated and the pump selected. The second heat exchanger can also be designed in a similar manner so that sufficient heat transfer is achieved.

The structural battery, as alluded to above, is a structural member typically forming part of the structural framework required by the application and a range of applications are possible. For example, the structural battery could—without limitation—form part of the chassis of a vehicle, a part of a fuselage of an aircraft or the hull of a watercraft, boat or ship, all requiring electric power for some purpose, for example using an electric motor as prime mover. The structural battery could form part of a portable device or a structure such as a building or a device such as a mobility device. The composite structure may be connected to other load bearing structures or structural members as required for applications such as those described above. Further description of the structural battery and its desired composite structure or composite sandwich structure is provided in the Applicant's International Patent Application filed 8 Aug. 2018 under Attorney Docket No. P42453PCAU, the contents of which are incorporated by reference. Whilst acting as a structural member, this is done without the weight involved with metal and metal alloy containers and trays meeting an important objective, especially for electric motor powered vehicles.

As described above, rate of heat addition or removal may depend on battery operating conditions. In an electric vehicle application, the temperature control means, such as a heat exchange system, can allow for conditions such as harsh acceleration, crashing or piercing scenarios where thermal control is very important. This aspect of the invention provides a method of temperature control in an electric vehicle comprising at least one structural battery comprising: a container of a first material; and a core for a plurality of electric cells provided within said container wherein the container and the core of the composite structure together form a structural member of the electric vehicle having resistance to shear forces, compression forces, tension forces, torsional forces and longitudinal and transverse bending forces imposed on said structural member by vehicle operation and wherein said core comprises a means for controlling temperature of said core, preferably within a predetermined temperature range, and further comprising the step of controlling temperature during a vehicle operating condition selected from the group consisting of harsh acceleration, crashing or piercing.

Conversely, the temperature control means can enable battery heating or pre-heating to enable efficient electrical vehicle operation under cold temperature operating conditions.

The composite structure of the invention may be more fully understood from the following description of exemplary embodiments thereof made with reference to the drawings in which:

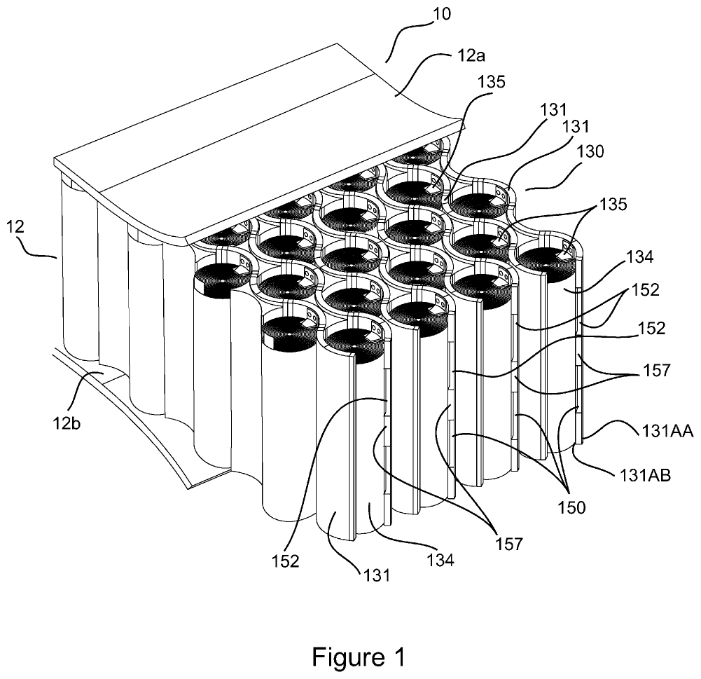

FIG. 1 shows an orthogonal cutaway view of a structural battery including a temperature control means according to one embodiment of the present invention.

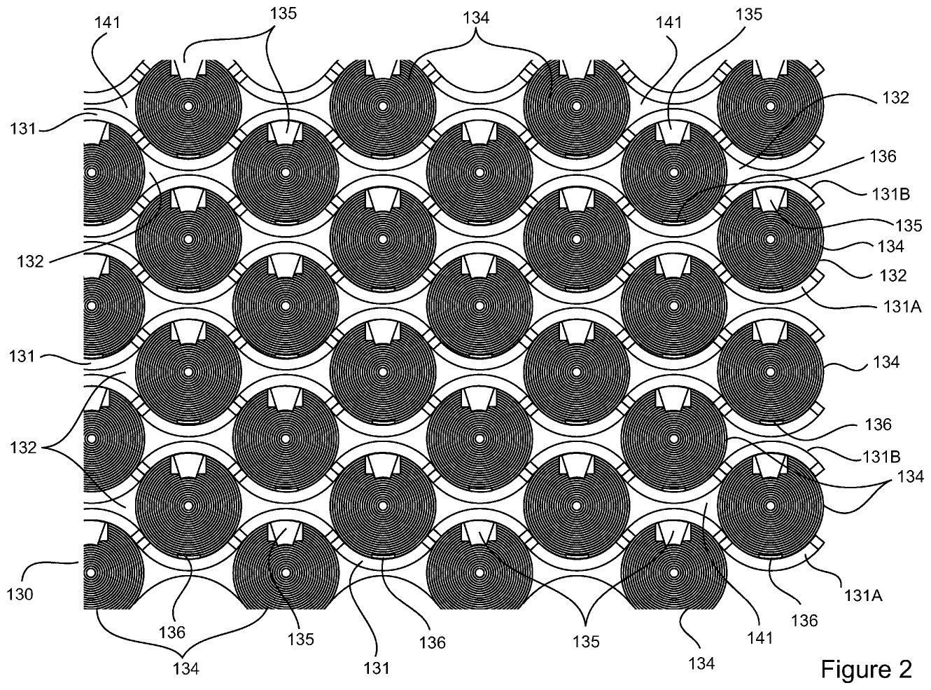

FIG. 2 shows a plan view of the core structure of FIG. 1.

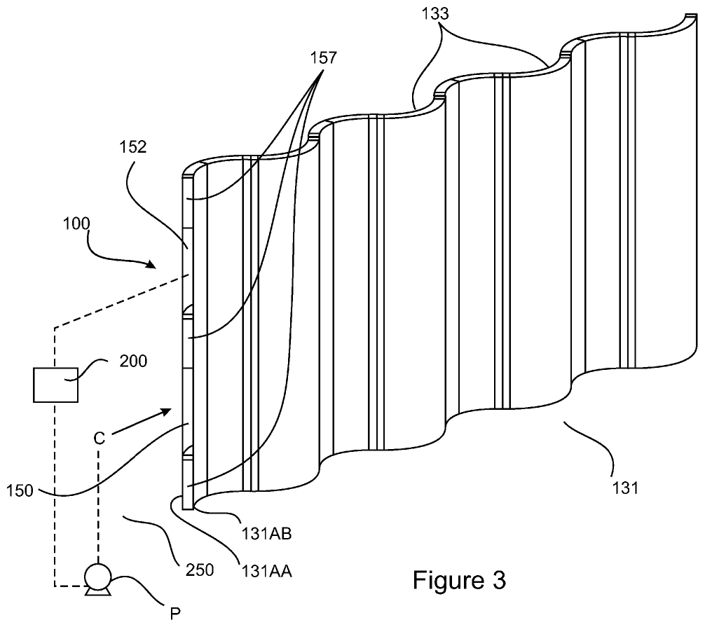

FIG. 3 shows a detail view of a core element of the core structure of FIGS. 1 and 2.

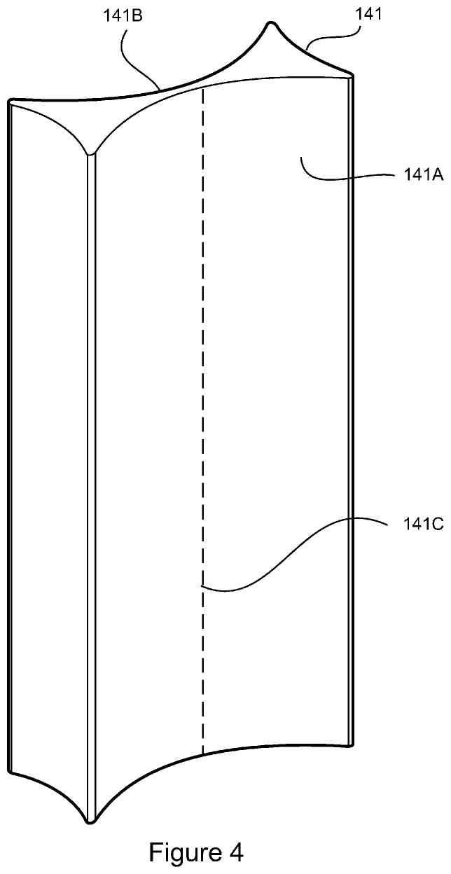

FIG. 4 shows an insulating spacer from the core structure as shown in FIGS. 1 and 2.

Referring now to FIGS. 1 and 2, there is shown a cutaway view of a structural battery 10 for delivering electric power to an application requiring electric power such as an electric motor vehicle (not shown) but not limited to this. Structural battery 10 includes a container 12 of a first, fibre reinforced composite material such as CFRP; and a core 130 of a second material for accommodating a plurality of electric cells 134 provided within the container 12. The first material may also include other materials resistant to longitudinal and transverse bending forces, preferably lightweight materials which may include light metals or metal alloys such as aluminium alloys. Container 12 includes respective upper and lower facing layers 12a and 12b (which though shown curved would typically be flat in practice) of sufficient strength to treat tension and compression loads. Facing layers 12a and 12b are of CFRP. The structural battery 10 therefore has a composite sandwich structure.

The structural battery 10 forms a structural member having resistance to compressive, shear and longitudinal and transverse bending forces imposed on the structural member by the electric motor vehicle whether stationary or in operation. Further description of the structural battery 10 and its composite sandwich structure, which approximates an “I” beam in structural characteristics, is provided in the Applicant's co-pending International Application filed 8 Aug. 2018 under Attorney Docket No. P42453PCAU, incorporated herein by reference.

Structure 130 forms the core of the structural battery 10. Core structure 130, which is intended to be resistant to compressive and shear loads, is also electrically and thermally conductive comprising a framework of core elements 131 of laminated lightweight structure comprising multiple corrugated aluminium sheets or layers 131AA and 131AB which are bonded together with a laminated structure in a corrugation moulding process in such a way as to leave generally cylindrical spaces 132 of circular section for accommodating electric cells 134 and connecting tabs or electrodes 135 and 136 in a manner avoiding short circuiting and other electrical malfunctions. One electric cell 134 is accommodated by each space 132. Electric cells 134 are desirably close packed within the core structure 130, desirably with a packing factor approaching that for hexagonal geometry.

Layers 131A and 131B are spaced apart by elongate insulating spacers 141 which also serve as structural links assisting in the provision of compressive strength and shear resistance. Insulating spacers 141, one of which is shown in detail in FIG. 4, have arcuate or concave surfaces 141A and 141 B and a dogbone shape when viewed end on or in plan. Such insulating spacers 141, having the requisite compatible shape, are included as blanks and may facilitate corrugation moulding. A polymeric insulating material, such as polyamide, may be used for spacers 141. The spacer material may be intumescent. Spacers 141 may also include information links, such as a thermistor 141C, for sensing battery parameters such as battery operating temperature.

Referring further to core structure 130 as shown in FIGS. 1 and 2, the layers 131 are formed of second thermally and electrically conductive material, aluminium or copper, these layers 131—including layers or sheets 131A and 131B—being separated by elongate insulating spacers 141 with arcuate or concave surfaces 141A and 141B and having a dogbone shape when viewed end on or in plan as shown in FIG. 4. The dimensions of concave surfaces 141A and 141B are selected to neatly accommodate electric cells 134. The insulating material can be included as blanks for corrugation moulding, forming the dogbone shaped spacers 141 during fabrication. A ceramic or polymeric insulating material, such as polyamide, may be used. An intumescent material may be used to enable phase change cooling. A high shear strength material may also be selected. A material with strong adhesive properties such as epoxy resin could also be selected with or without fillers to enhance the aforesaid properties. Spacers 141 may also include information links and sensors, such as thermistors, for sensing battery parameters such as temperature.

The number of electric cells 134 and number of spaces 132 selected to accommodate such electric cells 134 is determined with reference to the electric power requirements of the application. Further description is included in the Applicant's co-pending International Patent Application filed under Attorney Docket No. P42453PCAU, incorporated herein by reference. Many, perhaps thousands of, electric cells 34 (134) may be required for the application.

Electric cells 134 of various types could be selected and this is not critical though suitable batteries could be selected from rechargeable batteries especially from the lithium ion battery class, such as for example 18650 or 2170 type batteries which have a cylindrical geometry and are rated at 3.7 v per cell. In the case of an electric motor vehicle, the selected electrical cells 134 would enable the structural battery 10, while having the required structural properties to act as a structural member, to have a relatively shallow depth in relation to length and breadth.

Electrical connections between the electric cells 134 are described in the Applicant's co-pending International Patent Application filed 8 Aug. 2017 under Attorney Docket No. P42682PCAU, the contents of which are incorporated herein by reference. The plurality of interconnected electric cells 134 generate heat during operation creating a risk of overheating, inefficient operation and damage to or failure of structural battery 10. Temperature control is required.

To that end, the temperature within the structural battery 10 and particularly within its core structure 130 is controlled by a heat exchanger system 250 to maintain structural battery operating temperature within acceptable limits, for example 15° C. to 35° C. Heat exchanger systems 250 operate through heat exchange between the electric cells 134 and honeycomb structure 130 and a heat transfer fluid selected not to interfere with battery 10 operation, here a refrigerant or ethylene glycol, is circulated so that heat generated by the electric cells 134 is absorbed and the structural battery 10 cooled to maintain operating temperature within the acceptable limits.

Referring again to FIG. 2 and core structure 130, electrical connections are made between electric cells 134, accommodated within circular spaces 132 formed by the corrugated layers 131 of core structure 130. Each electric cell 134 is, through positive and negative electrodes 135 and 136, connected to negative and positive terminals of other electric cells 134 within the honeycomb structure 130 to provide both series and parallel connections providing the required voltage and capacity requirements for the battery application. Further description is included in the Applicant's co-pending International Patent Application filed 8 Aug. 2018 under Attorney Docket P42682PCAU, the contents of which are incorporated herein by reference. Heat is generated by the impedance of electric cells within the core structure 130 and so structural battery 10 requires thermal control to maintain operating temperature within a desired temperature range, again 15° C. to 35° C. In some cases, battery heating may be necessary—for example under cold ambient conditions—and the temperature control system enables this.

Core elements 131 are comprised of corrugated aluminium sheets 131AA and 131AB which are bonded in a laminate structure through are separated by insulating spacers 157 (for example of ceramic material) included during fabrication. However, to enable battery 10 cooling, the insulating spacers 157 do not extend the full length of layers 131A and 131B, rather leaving inter-connected galleries 150 and 152, forming part of first heat exchanger 100, through which heat transfer fluid, such as a refrigerant, is circulated by fixed or variable speed pump P during battery operation. The interconnected galleries 150 and 152 form a first heat exchanger of heat exchanger system 250. This enables battery temperature to be controlled. Direction of heat transfer fluid flow as driven by pump P is indicated by arrows C in FIG. 3. Heat transfer fluid is directed first through galleries 150 and returns, following the heat transfer process, through return galleries 152. The galleries 150 and 152 can also transport heat transfer fluid to heat the structural battery 10 if required under cold ambient conditions.

Refrigerant warms during the cooling process and to remove this heat, where required, heat exchanger system 250 includes a second heat exchanger 200 to enable heat exchange between the refrigerant and air or other medium. The second heat exchanger 200 could take the form of a finned heat exchanger, chiller or radiator. The refrigerant can then be recirculated through the heat exchanger system 250 to galleries 150, 152 and the heat transfer process continues in this manner. Again, if battery 10 requires heating, the cooled heat transfer fluid can be reheated in suitably configured second heat exchanger 200.

The heat exchanger system 250 described above includes suitably rated first and second heat exchangers 100 and 200 to control the temperature of the core 130 and maintain the structural battery 10 at acceptable operating temperature. That is, heat output (or heat requirement) from the interconnected electric cells 134 can be calculated allowing, with consideration of other relevant parameters, estimation of the battery operating temperature under particular conditions. First heat exchanger 100 may then be designed to control the required structural battery operating temperature within acceptable limits. Required heat transfer fluid flow (C) rates can be calculated and the pump P selected. The second heat exchanger 200 can also be designed in similar manner. Heat transfer fluid flow C may be controlled by a suitable electronic control unit through controlling speed of variable speed pumps P dependent on structural battery 10 temperature, as sensed by information links as described above and, for example, embedded in insulating spacers 141 for core structure 130. Heat exchangers 100 and 200 can also be configured to enable structural battery heating, for example under cold ambient conditions.

As described above, the structural battery 10 can be used in a range of applications including in fixed structures, mobility devices and portability devices. A potential application is to electric motor vehicles. In such case, a bank of structural batteries 10 could accommodate a very large number of electric cells 134, potentially thousands, and form a floor pan for an the electric motor vehicle. Weight, which is significantly lower than that involved with conventional metal and metal alloy battery containers or trays, would then be focused in the lowest point of the vehicle where one or a bank of structural batteries provides a load bearing beam between front and rear wheels, left and right wheels (where provided) and a torsionally rigid member between all wheels.

Structural battery 10 is rechargeable and not intended for replacement under normal circumstances. However, it could be made replaceable if desired. This itself could depend on the application.

Modifications and variations to the structural battery described herein may be apparent to the skilled reader of this disclosure. Such modifications and variations are deemed within the scope of the present invention.

1. A structural battery for delivering electric power to an application requiring electric power comprising:
a container of a first material; and
a core for a plurality of electric cells provided within said container
wherein the container and the core of the composite structure together form a structural member having resistance to shear forces, compression forces, tension forces, torsional forces and longitudinal and transverse bending forces imposed on said structural member by the application and wherein said core comprises temperature control means for controlling temperature of said core, preferably within a predetermined temperature range.

2. The structural battery of claim 1, wherein the predetermined temperature range for the structural battery is between 0° C. to 50° C., preferably 15° C. to 35° C.

3. The structural battery of claim 1 wherein the temperature control means includes a heat absorbing material located within the core.

4. The structural battery of claim 3 wherein the heat absorbing material is arranged throughout the core as elements or units, optionally of a material that changes state or phase, the change of state or phase requiring sufficient heat to prevent thermal runaway.

5. The structural battery of claim 1 wherein said
temperature control means includes a heat exchanger system that includes first heat exchanger(s) to add or remove heat from the core so that core temperature or battery operating temperature is maintained within the predetermined temperature range.

6. The structural battery of claim 5 wherein said first heat exchanger operates through heat transfer to and from a heat transfer fluid, wherein a controller controls heat transfer fluid flow rate to reduce error between a target battery operating temperature and sensed temperature depending on battery operating conditions.

7. The structural battery of claim 6 wherein said heat exchanger system includes second heat exchanger(s) to add or remove heat from the heat transfer fluid enabling recirculation for temperature control.

8. The structural battery of claim 1 wherein the core accommodates the electric cells within one or more spaces pre-formed in a material or a sub-structure resistant to compression and shear loads as well as temperature, a portion of the material or sub-structure being made thermally conductive to assist heat transfer and temperature control.

9. The structural battery of claim 8, wherein said core structure is formed by a framework of core elements or layers, optionally forming a honeycomb structure, the core elements including fluid passage means through which heat transfer fluid flows to enable heat transfer to or from the electric cells, and their accommodating spaces, to or from the heat transfer fluid.

10. The structural battery of claim 9, wherein said core elements are electrically and thermally conductive.

11. The structural battery of claim 9, wherein the core elements are laminated sheets.

12. The structural battery of claim 11 wherein the laminated sheets are corrugated to accommodate electric cells.

13. The structural battery of claim 11 wherein a plurality of parallel disposed fluid passage means extend through said sheet core elements.

14. The structural battery of claim 11 wherein laminated sheet layers are spaced apart by elongate insulating spacers, preferably having dogbone shape and comprising arcuate or concave surfaces for neatly accommodating electric cells.

15. The structural battery of claim 14 wherein said insulating spacers are intumescent for enabling phase change cooling.

16. The structural battery of claim 14 wherein said insulating spacers comprise high shear strength polymeric material.

17. An electric device comprising a composite structure as claimed in claim 1 as a structural member within said electric device.

18. The device of claim 17 selected from the group consisting of portable devices, mobility devices and electric vehicles.

19. A method of temperature control in an electric vehicle comprising at least one structural battery comprising:
a container of a first material; and
a core for a plurality of electric cells provided within said container
wherein the container and the core of the composite structure together form a structural member of the electric vehicle having resistance to shear forces, compression forces, tension forces, torsional forces and longitudinal and transverse bending forces imposed on said structural member by vehicle operation and wherein said core comprises a means for controlling temperature of said core, preferably within a predetermined temperature range, and further comprising the step of controlling temperature during a vehicle operating condition selected from the group consisting of harsh acceleration, crashing or piercing.

20. The structural battery of claim 2 wherein the temperature control means includes a heat absorbing material located within the core.

21. The structural battery of claim 3 wherein said temperature control means includes a heat exchanger system that includes first heat exchanger(s) to add or remove heat from the core so that core temperature or battery operating temperature is maintained within the predetermined temperature range.

22. The structural battery of claim 4 wherein said temperature control means includes a heat exchanger system that includes first heat exchanger(s) to add or remove heat from the core so that core temperature or battery operating temperature is maintained within the predetermined temperature range.

23. The structural battery of claim 10, wherein the core elements are laminated sheets.

24. The structural battery of claim 12, wherein a plurality of parallel disposed fluid passage means extend through said sheet core elements.

25. The structural battery of claim 12, wherein laminated sheet layers are spaced apart by elongate insulating spacers, preferably having dogbone shape and comprising arcuate or concave surfaces for neatly accommodating electric cells.

26. The structural battery of claim 13, wherein laminated sheet layers are spaced apart by elongate insulating spacers, preferably having dogbone shape and comprising arcuate or concave surfaces for neatly accommodating electric cells.

27. The structural battery of claim 15, wherein said insulating spacers comprise high shear strength polymeric material.
